(19) United States
(12) Patent Application Publication
(10) Pub. No.: US 2005/0025040 A1
(43) Pub. Date: Feb. 3, 2005

(54) Method and apparatus providing adaptive learning in an orthogonal frequency division multiplex communication system

(75) Inventors: Clive K. Tang, Irving, TX (US); Victor J. Stolpman, Dallas, TX (US)

Correspondence Address: HARRINGTON & SMITH, LLP, 4 RESEARCH DRIVE, SHELTON, CT, 06484-6212, US

(73) Assignee: Nokia Corporation

(21) Appl. No.: 10/629,124

(22) Filed: Jul. 29, 2003

(51) Int. Cl. H04J 11/00; H04J 1/00

(52) U.S. Cl. 370/208; 370/465; 370/480

(57) ABSTRACT

Disclosed is a method to operate an orthogonal frequency duplex multiplexing (OFDM) communications system, and an OFDM system that operates in accordance with the method. The method includes, when transmitting data over a plurality of OFDM sub-channels from an OFDM transmitter (12A) to an OFDM receiver (12B) through a channel (24), operating an adaptive learning automaton (50) to adjust values of modulation coding scheme (MCS) switching thresholds so as to maximize at least one selected performance criterion; based on the values of the switching thresholds, selecting a MCS and modulating data with the selected MCS and transmitting the modulated data over at least some of the sub-channels. The method further includes receiving the data at the OFDM receiver and demodulating the received data using a demodulator that corresponds to the selected MCS.

### TECHNICAL FIELD

This invention relates generally to wireless communications systems and, more specifically, relates to both mobile and fixed wireless communications systems that employ Orthogonal Frequency Division Multiplex (OFDM) techniques.

### BACKGROUND

Frequency division multiplexing (FDM) is a technology that transmits multiple signals simultaneously over a single transmission path, such as a cable or wireless system. Each signal travels within its own unique frequency range (carrier), which is modulated by the data (text, voice, video, etc.).

An orthogonal FDM (OFDM) spread spectrum technique distributes the data over a large number of carriers that are spaced apart at defined frequencies. This spacing provides the “orthogonality” of the OFDM approach, and prevents the demodulators from seeing frequencies other than their own. The benefits of OFDM are high spectral efficiency, resiliency to RF interference, and lower multipath distortion. This is useful because in a typical terrestrial wireless communications implementation there are multipath channels (i.e., the transmitted signal arrives at the receiver using various paths of different length). Since multiple versions of the signal interfere with each other (inter-symbol interference (ISI)), it becomes difficult to extract the original information.

OFDM has been successfully deployed in indoor wireless LAN and outdoor broadcasting applications. OFDM beneficially reduces the influence of ISI with a complexity that is less than that of typical single carrier adaptive equalizers. OFDM has also been found to work well in multipath fading channels. These and other advantages render OFDM a strong candidate for use in future mobile communication systems, such as one being referred to as 4G (fourth generation).

In a frequency selective fading channel each sub-carrier is attenuated individually. The resultant sub-channel frequency functions are frequency-variant and may also be time-variant, i.e. the channel magnitude may be highly fluctuating across the sub-carriers and may vary from symbol to symbol. Hence, adaptive modulation may be used to advantage to improve the error performance and data throughput in an OFDM modem (modulator/demodulator) by assigning different modulation and coding schemes to different sub-carriers.

However, one fundamental issue in deploying adaptive modulation is to determine what modulation and coding scheme (MCS) to use. For a system with several pre-defined MCS available, the problem may be viewed as the determination of switching thresholds, i.e., when to switch from using one MCS to using another MCS. Virtually all past investigations into this problem that are known to the inventors were based on heuristic methods, or employed limited analytical resources, usually under un-coded conditions.

One approach from the literature is a so-called “target BER approach”, as described by H. Rohling and R. Grunheid, “Performance of an OFDM-TDMA Mobile Communication System”, IEEE 46th Vehicular Technology Conference, April 28 to May 1, 1996, Volume 3, pp. 1589-1593; and A. Czylwik, “Adaptive OFDM for Wideband Radio Channels”, IEEE GLOBECOM 96, Nov. 18-22, 1996, Volume 1, pp. 713-718. In the target BER approach the thresholds are set to be the signal-to-noise ratios (SNRs) needed for the given modulation and coding schemes in order to meet a target BER. While this approach may insure that a target BER is achieved, but does not maximize the data throughput. Another prior art method treats the issue as a parameter optimization problem and employs analytical optimization techniques (see, for example, B. S. Krongold, K. Ramchandran and D. L. Jones, “Computationally Efficient Optimal Power Allocation Algorithms for Multicarrier Communication Systems”, IEEE Trans. on Communications, Vol.48, No. 1, 2000, pp. 23-27). In this approach one would typically seek to maximize the data rate (bits/OFDM symbol) subject to a BER/SER bound and other constraints (e.g. power). However, this approach does not necessarily mean that the net throughput is optimized, especially in a packet-based system. Moreover, this approach is tailored for a specific modulation scheme, channel condition and operating constraints, and needs to be re-evaluated if any one of them changes.

Discussing these prior art approaches now in further detail, in the “targeted BER approach” the thresholds are derived from the BER curves under AWGN. In such an approach a set of Gaussian BER curves for the available MCSs is plotted, and the SNR thresholds are read from the graph for a target BER. While this approach may insure a certain maximum tolerable BER, it has no control over the resultant throughput, which may be a more important performance criterion in some applications, e.g., when downloading files. Variants on the targeted BER approach are also available, for example the thresholds may be shifted according to the mean SNR across a block of sub-carriers (see, for example, R. Grunheid, E. Bolinth and H. Rohling, “A Blockwise Loading Algorithm for the Adaptive Modulation Technique in OFDM Systems”, IEEE 54th Vehicular Technology Conference, October 2001, Volume 2, pp. 948-951), or one may estimate the overall BER for all available modulation schemes in a group of sub-carriers and select the scheme that gives the highest throughput while also satisfying a BER bound (see, for example, T. Keller and L. Hanzo, “Adaptive Modulation Techniques for Duplex OFDM Transmission”, IEEE Trans. on Vehicular Technology, Vol. 49, No. 5, September 2000, pp. 1893-1906), or one may adjust the power of the individual sub-carriers to reduce the excessive margin (see, for example, T. Yoshiki, S. Sampei and N. Morinaga, “High Bit Rate Transmission Scheme with a Multilevel Transmit Power Control for the OFDM based Adaptive Modulation Systems”, IEEE 53rd Vehicular Technology Conference, May 2001, Volume 1, pp. 727-731).

The other technique, i.e., the “parameter optimization approach”, formulates the modulation selection issue as a parameter optimization problem. The aim is to optimize the rate (bits/symbol) subject to a number of constraints. For instance, Krongold et al. (B. S. Krongold, K. Ramchandran and D. L. Jones, “Computationally Efficient Optimal Power Allocation Algorithms for Multicarrier Communication Systems”, IEEE Trans. on Communications, Vol.48, No. 1, 2000, pp. 23-27) proposed a Lagrange bisection solution that maximizes the rate (bits/symbol) subject to a total power constraint and a fixed error probability bound. An additional practical constraint is that the rate should be an integer number of bits/symbol. Unfortunately, channel coding, which is frequently employed to combat fading, may be difficult to incorporate in such an analytical approach. A certain channel distribution is also often assumed, in other words the derived solution only works for a given channel condition and should be re-evaluated when the channel changes. Moreover, in a packet-data based system with channel coding, it may be more desirable to maximize the net data throughput, defined as (1-PER)*data_rate, where data_rate is the actual data rate in packets/symbols per time unit (or other normalized values), rather than the raw data rate, and PER is the Packet Error Rate. However this is difficult to perform analytically. In fact, little or no literature is available that deals with packet errors and the associated optimization of throughput for a coded OFDM system.

In general, analytical modeling is basically inaccurate, and may at best be simply an approximation of many practical operating conditions. The heuristic method is often subjective, represents but one of the many solutions available, and may not provide the most optimal performance.

Based on the foregoing, it should be appreciated the problem of optimally making adjustments of MCS switching thresholds in an adaptive OFDM modem, to improve or maximize data throughput, has not been adequately resolved.

### SUMMARY OF THE PREFERRED EMBODIMENTS

The foregoing and other problems are overcome, and other advantages are realized, in accordance with the presently preferred embodiments of these teachings.

In accordance with this invention an OFDM system and method operates in an on-line adaptive mode to dynamically alter the MCS switching thresholds as the channel conditions vary. The approach of this invention is of a generic nature, and is not tailored for a specific environment or channel conditions. As a result, the approach of this invention has a wide applicability and may be applied to different system configurations and scenarios, especially when channel coding is employed. The appropriate adjustment of the switching thresholds improves the error performance and the data throughput, both of which can result in an increase in system capacity.

Disclosed is a method to operate an orthogonal frequency duplex multiplexing (OFDM) communications system, and an OFDM system that operates in accordance with the method. The method includes, when transmitting data over a plurality of OFDM sub-channels from an OFDM transmitter to an OFDM receiver through a channel, operating an adaptive learning automaton to adjust values of modulation coding scheme (MCS) switching thresholds so as to maximize at least one selected performance criterion; based on the values of the switching thresholds, selecting a MCS and modulating data with the selected MCS and transmitting the modulated data over at least some of the sub-channels. The method further includes receiving the data at the OFDM receiver and demodulating the received data using a demodulator that corresponds to the selected MCS.

For a mode 1 operational configuration the MCS assignment is performed every OFDM symbol, and the MCS allocation determines the number of packets that can be accommodated in the OFDM symbol. Before the next OFDM symbol is transmitted each sub-carrier's SNR is re-examined, and the sub-carriers are then loaded with another set of packets having the appropriate MCS. For a mode 2 configuration the MCS assignment is performed every OFDM frame. At the beginning of an OFDM frame each sub-carrier's SNR is examined and a suitable MCS allocated. Upon completion of transmission of a frame the sub-carriers' SNR are re-examined, and the sub-carriers are loaded with another frame of packets with the appropriate MCS. For the mode 1 configuration the MCS assignment is performed every OFDM symbol, and the MCS allocation determines the number of packets that can be accommodated in the OFDM symbol. The data symbols within the packets are interleaved across all the sub-carriers, thus the packets should share a similar error probability, even though the data symbols may be carried by different MCS in different sub-carriers. Before the next OFDM symbol is transmitted each sub-carrier's SNR is re-examined, and the sub-carriers are then loaded with another set of packets having the appropriate MCS.

For the mode 2 configuration the MCS assignment is performed every OFDM frame, which is defined here as the number of OFDM symbols required to transmit a complete packet in a sub-carrier with the lowest MCS order. At the beginning of an OFDM frame, each sub-carrier's SNR is examined and a suitable MCS allocated. The same MCS is maintained for the entire packet that spreads across an OFDM frame. This approach assumes slow fading, so that a sub-carrier's condition is relatively constant over a frame of OFDM symbols. Upon completion of transmission of a frame the sub-carriers' SNR are re-examined, and the sub-carriers are loaded with another frame of packets with the appropriate MCS. Note that no rate matching is performed in either mode 1 or mode 2, as the goal is to load up the packets according to the sub-channel conditions. If a sub-carrier's SNR is too low it is disabled to reduce the average PER. The two modes may be applied to both coded and un-coded packets.

The use of adaptive learning is applied, in accordance with an aspect of this invention, to an OFDM modem. Specifically, a performance-goal orientated technique is provided to adjust the MCS switching thresholds so as to improve or maximize a chosen performance criterion, for example the data throughput. One particularly attractive feature of the method provided in accordance with this invention is its general nature, i.e., it is not designed to accommodate any specific modulation and coding schemes, nor does it assume any certain fading channel conditions. Instead, the inventive method provides a generic procedure that operates independent of the aforementioned variants, and which can be deployed in different system configurations.

The automaton operates differently in modes 1 and 2 because of the different ways the packets are loaded onto the sub-carriers. In mode 1, the automaton is invoked once every OFDM symbol, thus the transmission of an OFDM symbol represents a trial of an automaton learning process. In mode 2, the automaton is activated once every OFDM frame, and thus the transmission of a frame of OFDM symbols is regarded as a trial. In successive trials of both modes, the probabilities of selecting the undesirable actions (that result in a low throughput) gradually decrease, while that of picking the best action (that results in the best throughput) progressively increases to unity.

In a further embodiment of this invention the updating of the MCS switching thresholds is performed once per data packet, and thereby the automaton learning process converges more rapidly to the optimal state.

### BRIEF DESCRIPTION OF THE DRAWINGS

The foregoing and other aspects of these teachings are made more evident in the following Detailed Description of the Preferred Embodiments, when read in conjunction with the attached Drawing Figures, wherein:

FIG. 1 is simplified block diagram of an N sub-carrier OFDM modem;

FIG. 2 illustrates a snapshot of a magnitude frequency function of a two-path Rayleigh fading channel;

FIG. 3 shows a mode 1 loading, where multiple packets are loaded across the sub-carriers into an OFDM symbol;

FIG. 4 shows a mode 2 loading, where each sub-carrier is loaded with its own packet. Each packet spreads across a number of OFDM symbols;

FIG. 5 is a block diagram that illustrates a closed-loop system to adapt the MCS switching thresholds;

FIG. 6 illustrates a stochastic learning automaton operating in a random environment;

FIG. 7 is a block diagram of adaptive OFDM system;

FIG. 8 is a graph showing Bit Error Rate (BER) curves of fixed QPSK and 8PSK modulation schemes under Additive White Gaussian Noise (AWGN) conditions;

FIG. 9 is a graph showing throughput (TP) curves for adaptive modulation with four switching threshold sets, mode 1;

FIG. 10 is a graph showing throughput curves for adaptive modulation with the four switching threshold sets, mode 2;

FIG. 11 is a graph showing throughput curves for fixed QPSK and 8PSK modulation schemes, mode 1;

FIG. 12 is a graph showing throughput curves for fixed QPSK and 8PSK modulation schemes, mode 2;

FIG. 13 is a graph showing probability convergence curves of the desired action, mode 1;

FIG. 14 is a graph showing throughput curves for adaptive modulation with automaton selected switching thresholds and fixed QPSK and 8PSK modulation schemes, mode 1;

FIG. 15 is a graph showing probability convergence curves of the desired action, mode 2;

FIG. 16 is a graph showing throughput curves for adaptive modulation with automaton selected switching thresholds and fixed QPSK and 8PSK modulation schemes, mode 2;

FIG. 17 is a graph showing an average loss in throughput while a learning scheme converges, mode 1;

FIG. 18 is a graph showing an average loss in throughput while a learning scheme converges, mode 2;

FIG. 19 is a logic flow diagram that illustrates a method of initializing a stochastic learning automaton system in accordance with an aspect of this invention;

FIG. 20 is a logic flow diagram that illustrates a method of operating the stochastic learning automaton system, in mode 1 operation, in accordance with a first embodiment of this invention;

FIG. 21 is a logic flow diagram that illustrates a method of operating the stochastic learning automaton system, in mode 2 operation, further in accordance with the first embodiment of this invention;

FIG. 22 is a logic flow diagram that illustrates a method of operating the stochastic learning automaton system, in mode 1 operation, in accordance with a second, enhanced embodiment of this invention that provides for faster convergence during the learning period;

FIG. 23 is a logic flow diagram that illustrates a method of operating the stochastic learning automaton system, in mode 2 operation, further in accordance with the second embodiment of this invention;

FIG. 24 is a graph showing candidate thresholds and the resulting active regions in mode 2, further in accordance with the second embodiment of this invention;

FIG. 25 is a graph showing a probability convergence curve of the desired action, mode 1, in accordance with a second, enhanced adaptive learning embodiment of this invention;

FIG. 26 is a graph showing a probability convergence curve of the desired action, mode 2 in accordance with the second, enhanced adaptive learning embodiment of this invention;

FIG. 27 is a graph showing an average loss in TP, while the learning scheme converges, mode 1, in accordance with the second, enhanced adaptive learning embodiment of this invention; and

FIG. 28 is a graph showing an average loss in TP, while the learning scheme converges, mode 2, in accordance with the second, enhanced adaptive learning embodiment of this invention.

### DETAILED DESCRIPTION OF THE PREFERRED EMBODIMENTS

By way of introduction, one technique for deploying adaptive modulation in an OFDM modem, in order to take advantage of the sub-channel frequency diversity, is to examine the individual sub-channel condition (via its SNR as a metric, for example) and then assign an appropriate modulation and coding scheme to that sub-channel. Therefore a basic issue is to determine how to select the appropriate MCS. For a system in which several pre-defined MCSs are available, the issue essentially amounts to when to switch from one MCS to another, i.e. the determination of switching thresholds. This invention provides an on-line adaptive learning technique that is capable of adjusting the MCS switching thresholds dynamically to improve or maximize the throughput. Unlike the prior art that is either heuristic or information theory based, this invention uses an adaptive control approach. An aspect of the self-learning technique of this invention is that it does not require a dedicated training signal, instead it utilizes the average data throughput as a performance measure to direct a learning process that adjusts the MCS switching threshold values. Another aspect of this invention is that it does not make any assumptions as to the operating environment, i.e., no specific knowledge of the fading channel conditions or modulation and coding techniques need be assumed. This is an important practical advantage over analytical techniques, as analytic techniques often are required to assume a certain channel distribution, and may not readily accommodate various channel coding cases. This invention also does not need the throughput to be available as an analytical function of the switching thresholds, which is typically unavailable in most practical systems. These features render the performance-goal orientated approach of this invention more generic and independent of the underlying modulation and coding schemes, and it thus possesses a wider applicability to various system configurations and channel conditions.

This invention can be implemented in either the transmitter or the receiver, or in both, of an OFDM system using software, hardware, or a combination of software and hardware. The software is assumed to be embodied as program code and stored in a computer-readable medium that directs the operation of a data processor, such as a digital signal processor (DSP) and/or a general purpose data processor that is resident at either one or both of the transmitter 12A and receiver 12B. A hardware synthesis of a learning automaton using basic logic elements is known from the literature (see, for example, P. Mars and W. J. Poppelbaum, “Stochastic and Deterministic Averaging Processors”, Peter Peregrinus, 1981). A performance function (e.g. throughput) may be evaluated at the receiver and fed back to the transmitter for use by the adaptive learning technique of this invention. Alternatively, the adaptive learning technique of this invention may be implemented at the receiver and the switching threshold values sent to the transmitter. In either case a two-way signaling path is assumed to exist between the transmitter and receiver to carry the necessary control information, for example the channel conditions. In some embodiments it may be desirable to use blind detection to reduce the amount of signaling.

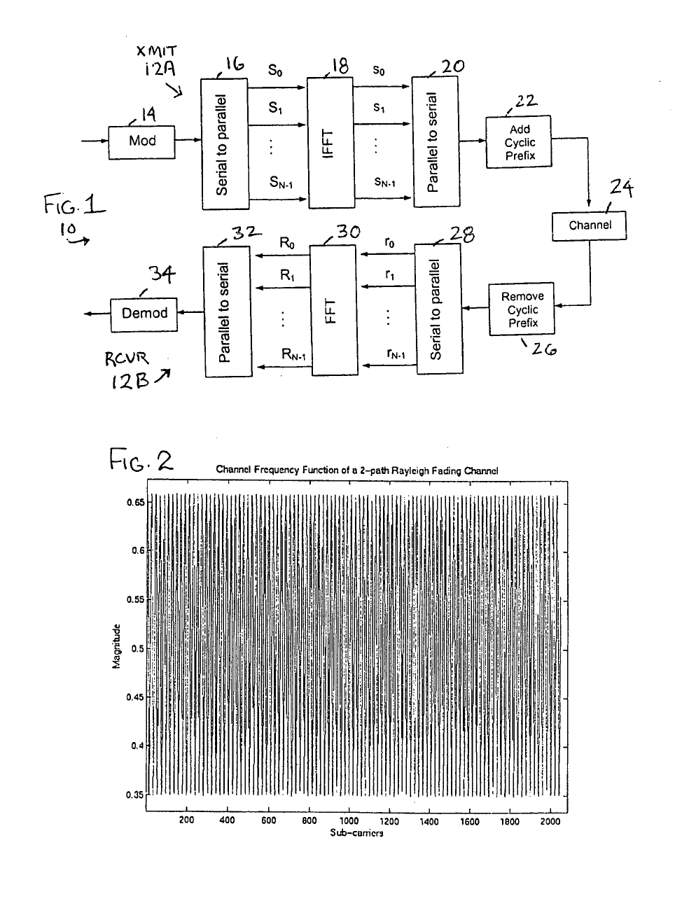

A block diagram of a N sub-carrier OFDM modem 10, also referred to herein as an OFDM transceiver or an OFDM system, is shown in FIG. 1. At the transmitter 12A a modulator 14 sends N complex symbols Sₙ, 0≦n≦N−1 that are multiplexed in a serial to parallel converter 16 to N sub-carriers. An Inverse Fast Fourier Transform (IFFT) block 18 translates the N frequency-domain symbols into N time-domain samples Sₙ, 0≦n≦N−1 that are applied to a parallel to serial converter 20, after which M cyclic prefix samples are inserted by block 22 before being transmitted over a time-varying and noise-corrupted channel 24. An OFDM symbol thus consists of N symbols in the frequency-domain, or N+M samples in the time-domain. At the receiver 12B the cyclic prefix is stripped from the received time-domain samples in the block 26, and the output is applied to a serial to parallel converter 28 that outputs the remaining data samples rₙ, 0≦n≦N−1. The separate received symbols are then input to a FFT block 30 to yield the received frequency-domain data symbols Rₙ, 0≦n≦N−1. The data symbols are then input to a parallel to serial converter 32, and the resulting symbol stream is then applied to a demodulator 34.

The impulse response of the channel is assumed to be constant for the duration of an OFDM symbol, therefore it can be characterized during such a period by the N-point Fourier Transform of the impulse response, which is referred to as the frequency domain channel transfer function (or more simply as the channel frequency function) Hₙ. For each sub-carrier n, the received complex data symbols can be expressed as,
Rₙ=Sₙ·Hₙ+nₙ (1)
where nₙ is an AWGN sample. Since the noise energy in each sub-carrier is independent of the channel frequency function, the local signal-to-noise ratio SNRₙ in sub-carrier n can be expressed as,
SNRₙ=|Hₙ|²·SNR (2)
where SNR is the overall signal-to-noise ratio. If no inter-sub-carrier-interference (ICI) or other impediments occur, then the value of SNRₙ determines the bit error probability for the sub-carrier n, and hence it may be used as a metric to assess the sub-channel condition.

To illustrate how the sub-channels can vary from one to another, one may consider by example an OFDM modem with 2048 sub-carriers and a simple two-path Rayleigh fading channel with a 20 Hz Doppler. FIG. 2 shows a snapshot of the magnitude frequency function of the fading channel. It can be seen that the frequency function varies widely across the 2048 sub-channels. Therefore, it is appropriate to deploy adaptive modulation to take advantage of the frequency diversity across the sub-channels.

One desirable goal is to achieve a good trade-off between throughput and error performance by using different modulation and coding scheme (MCS) for different sub-channels, although another possible goal may be to maximize the net data throughput only, regardless of the resultant error performance. Each sub-channel should ideally be examined individually and a suitable MCS allocated. However, if the number of sub-channels is large the computations required may be significant. Since adjacent sub-channels are often correlated (i.e., share a similar frequency function), the sub-channels may be divided into groups and the MCS allocated on a group-by-group basis. This reduces the computational load, but at the expense of a somewhat weakened performance (i.e., the MCS is not separately optimized for each individual sub-channel).

Typically the metric used to assess a sub-carrier's condition is the local SNRₙ, therefore a fundamental issue in deploying adaptive modulation is to determine what MCS to use according to the metric. For a system with several MCSs available (the MCS may be pre-determined by complexity or other implementation issues, for example), the matter of selecting a MCS may be alternatively viewed as the determination of the metric switching thresholds, i.e. when to switch between different MCSs. In some OFDM literature this is also known as the “bit loading” problem. It is well-known that the channel capacity in a spectrally-shaped Gaussian channel may be achieved by a water-filling distribution (see, for example, R. G. Gallager, “Information Theory and Reliable Communication”, John Wiley & Sons, New York 1968, and B. S. Krongold, K. Ramchandran and D. L. Jones, “Computationally Efficient Optimal Power Allocation Algorithms for Multicarrier Communication Systems”, IEEE Trans. on Communications, Vol.48, No. 1, 2000, pp. 23-27). However, in practice the optimal solution is difficult to achieve, and other sub-optimal solutions are used in the prior art, such as the those based on heuristic methods or analytical techniques, as was discussed above.

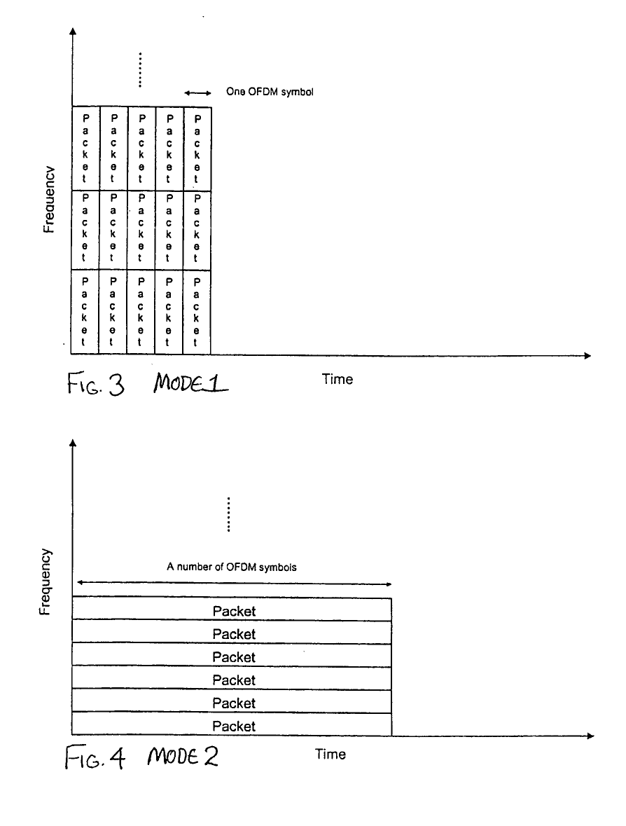

With the growing convergence towards an all-IP wireless network, many OFDM systems are packet-data based. For a packet-data based OFDM transceiver, there are at least two possible ways of configuring the sub-carriers to carry the data packets. One way, referred to herein as “mode 1”, is to distribute the packets across the sub-carriers. To facilitate the investigation the size of a packet is assumed to be small relative to the number of sub-carriers, so that several packets may be fitted into a single OFDM symbol. The size of the packet, however, is not restricted and large data packets may be conveyed utilizing more than one OFDM symbol. Transmission of a single OFDM symbol thus results in several complete packets being sent at the same time. Interleaving is preferably applied across all of the data symbols conveyed by the OFDM symbol (i.e., across all of the sub-carriers) to ensure that the packets share similar error probabilities, and to thus effectively create a homogenous channel. FIG. 3 shows the mode 1 approach of spreading the packets over frequency.

Another way of configuring the sub-carriers to carry the data packets, referred to herein as “mode 2”, is to load the individual sub-carrier with symbols from separate packets, and to spread the packets across the time domain, i.e., each sub-carrier is dedicated to carrying its own packet. For an OFDM modem with N sub-carriers, symbols from the N packets are thus transmitted simultaneously in a single OFDM symbol. A number of OFDM symbol are required to transmit a full packet in a sub-carrier. If the fade rate is low, or the OFDM symbol duration is short, the channel may be regarded as remaining relatively constant for the entire packet. FIG. 4 illustrates the mode 2 approach of spreading the packets over time.

Adaptive modulation, or bit loading, may be deployed in both modes of operation to improve the error and throughput performance. Since, after interleaving, the data symbols loaded across the sub-carriers may be considered to fade independently (see R. van Nee and R. Prasad, “OFDM for Wireless Multimedia Communications”, Artech House, Boston, January 2000), it is presently preferred that the switching thresholds are set to be identical amongst all the sub-carriers.

For the mode 1 configuration the MCS assignment is performed every OFDM symbol, and the MCS allocation determines the number of packets that can be accommodated in the OFDM symbol. The data symbols within the packets are interleaved across all the sub-carriers, thus the packets should share a similar error probability, even though the data symbols may be carried by different MCS in different sub-carriers. Before the next OFDM symbol is transmitted each sub-carrier's SNR is re-examined, and the sub-carriers are then loaded with another set of packets having the appropriate MCS.

For the mode 2 configuration the MCS assignment is performed every OFDM frame, which is defined here as the number of OFDM symbols required to transmit a complete packet in a sub-carrier with the lowest MCS order. At the beginning of an OFDM frame, each sub-carrier's SNR is examined and a suitable MCS allocated. The same MCS is maintained for the entire packet that spreads across an OFDM frame. This approach assumes slow fading, so that a sub-carrier's condition is relatively constant over a frame of OFDM symbols. Upon completion of transmission of a frame the sub-carriers' SNR are re-examined, and the sub-carriers are loaded with another frame of packets with the appropriate MCS. Note that no rate matching is performed in either mode 1 or mode 2, as the goal is to load up the packets according to the sub-channel conditions. If a sub-carrier's SNR is too low it is disabled to reduce the average PER. The two modes may be applied to both coded and un-coded packets.

As was mentioned above, for a system having several pre-determined MCS available the selection of an appropriate MCS may be viewed as the issue of determining the switching thresholds. It has been shown that the choice of switching thresholds can critically affect the system performance (see, for example, M. Nakamura, Y. Awad and S. Vadgama, “Adaptive Control of Link Adaptation for High Speed Downlink Packet Access (HSDPA) W-CDMA”, IEEE 5th International Symposium on Wireless Personal Multimedia Communications, October 2002, Volume 2, pp. 382-386).

One of the present inventors has previously described an adaptive learning approach for determining the adjustment(s) to switching thresholds, i.e., when to switch between different MCSs. Reference can be had to commonly assigned WO 02/45274 A2, “Apparatus, and Associated Method, for Selecting a Switching Threshold for a Transmitter Utilizing Adaptive Modulation Techniques”, Clive Tang; which claims priority from U.S. patent application Ser. No. 09/751,640, “Adaptive Learning Method and System to Adaptive Modulation (US 2002/0099529 A1); and U.S. patent application Ser. No. 10/008,094, filed Nov. 13, 2001, “Apparatus, and Associated Method, for Selecting Radio Communication System Parameters Utilizing Learning Controllers”, Clive Tang. Reference can also be made to U.S. patent application Ser. No. 10/448,860, filed May 30, 2003, entitled “Method and Apparatus Providing Enhanced Reservation Access Mode for a CDMA Reverse Channel”, Clive Tang et al., which discusses MCS determination in an Adaptive Modulation and Coding (AMC) system. The disclosures of all of these patent applications are incorporated by reference herein in their entireties.

The foregoing adaptive learning approach has roots in the control of complex industrial processes, where often little or no a priori information of the plant environment is known, and the processes are so complicated that little or no analytical modeling is possible. One technique to deal with this situation is to design an adaptive learning controller that is capable of estimating the unknown information during its operation so as to determine an optimal control action. A learning controller does not rely on or benefit from analytical modeling, does not suffer from its limitations, and is capable of offering better performance than heuristic schemes.

The use of adaptive learning is applied, in accordance with an aspect of this invention, to an OFDM modem. Specifically, a performance-goal orientated technique is provided to adjust the MCS switching thresholds so as to improve or maximize a chosen performance criterion, for example the data throughput. One particularly attractive feature of the method provided in accordance with this invention is its general nature, i.e., it is not designed to accommodate any specific modulation and coding schemes, nor does it assume any certain fading channel conditions. Instead, the inventive method provides a generic procedure that operates independent of the aforementioned variants, and which can be deployed in different system configurations.

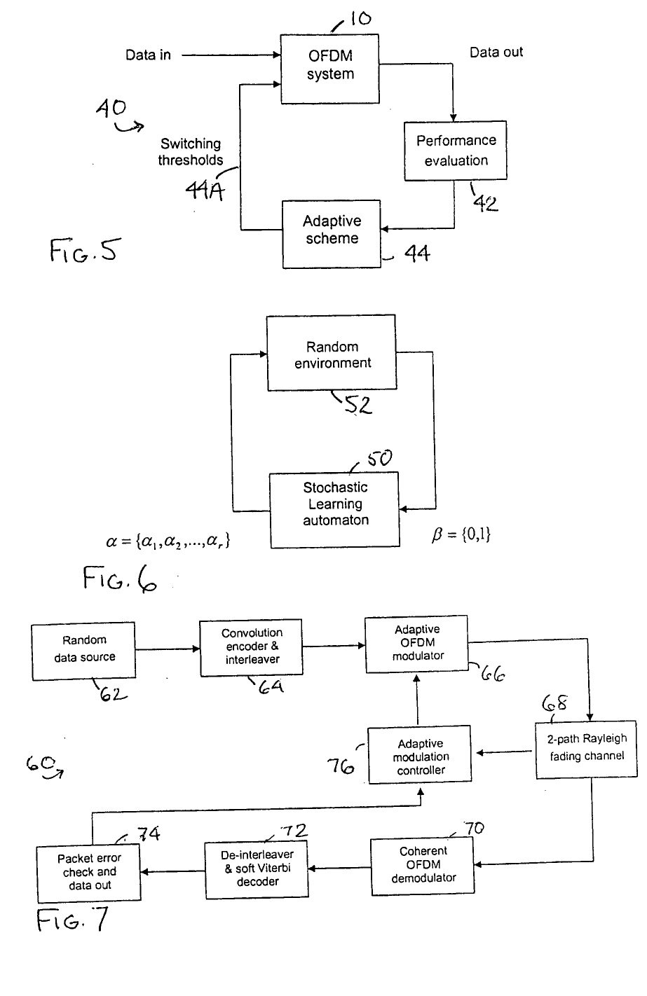

In such a target orientated approach the idea of adaptive control is applied to treat the OFDM transceiver 10 of FIG. 1 as a controllable system, with the switching thresholds as the control parameters and a performance function (e.g., throughput) as the system output to be maximized. An adaptive control block takes the performance function as an input and adjusts the switching thresholds to optimize the performance function. A block diagram of such an adaptive close-looped control system 40 is shown in FIG. 5, where an OFDM system, such as the system 10 shown in FIG. 1, is coupled with a performance evaluation block 42 that feeds an adaptive scheme block 44. The output of the adaptive scheme block 44 are the MCS switching thresholds 44A that are fed-back to the OFDM system 10. It should be noted that the performance evaluation block 42 may be a part of the OFDM system 10. In FIG. 5 it is illustrated as being external to the OFDM system 10 to emphasis the performance-goal oriented nature of this invention, and not by way of a limitation.

The adaptive scheme block 44 implements a method that monitors the performance of the OFDM system 10 and adjusts the MCS switching thresholds 44A accordingly. Because the performance is a function of the channel conditions, which are of a time-varying nature, it is desirable that the adaptive scheme block 44 control the switching thresholds 44A dynamically to maximize the throughput as the data is transmitted. Furthermore, because of the difficulties in deriving the throughput as an analytical function of the switching thresholds 44A, in a practical situation (e.g., when coding is invoked), it is preferred to use a self-learning method that does not utilize expressions of throughput and the thresholds, and that does not make any assumptions of the operating environment, so that it may more flexibly cope with different channel conditions. The adaptive scheme block 44 preferably implements global optimization in the case where the performance criterion applied by the performance evaluation block 42 is a multi-modal function. Equally important is that the adaptive scheme block 44 be implementable in a mobile transceiver having typically, limited processing power and memory resources. It is also desirable to not require the use of any dedicated training sequence in order to reduce the signaling overhead and conserve bandwidth. Based on the foregoing, one presently preferred, but not limiting, class of adaptive learning techniques, referred to as a stochastic learning automaton, is presently preferred for use.

Referring to FIG. 6, and in general, a stochastic learning automaton 50 may be defined as an element that interacts with a random environment 52 in such a manner as to improve a specific overall performance by changing its action probabilities dependent on responses received from the environment 52. The automaton 50 can be represented as a quintuple {β,φ,α,F,G}, where β is the input set (output from the environment), φ={φ₁, φ₂, . . . , φₛ} is a finite stage set and α={α₁, α₂, . . . , αᵣ} is the output action set (inputs to the environment). F: φ×β→φ is a state transition mapping and G: φ→α is the output mapping.

Focusing now on the variable structure automaton described by the triple {β,T,α}, where T denotes the rule by which the automaton 50 updates the probability of selecting certain actions. At stage n, assuming r actions each selected with probability pᵢ(n)(i=1,2, . . . ,r) one has:
pᵢ(n+1)=T[pᵢ(n),α(n),β(n)].

A binary random environment 52 (also known as a P model) is defined by a finite set of inputs α={α₁, α₂, . . . , αᵣ} (outputs from the automaton 50), an output set β=(0,1) and a set of penalty probabilities c={c₁, c₂, . . . , cᵣ}. The output β(n)=0 at stage n is called a favorable response (success), and β(n)=1 is called an unfavorable response (failure). The penalty probabilities are defined as,
cᵢ=Prob[β(n)=1|α(n)=αᵢ]
Both linear and non-linear forms of updating algorithms T have been considered. The most widely used are the class of linear algorithms which include linear reward/penalty (LRP), linear reward/ε penalty (LRεP), and linear reward/inaction (LRI). For the LRP scheme, if an automaton tries an action αᵢ that results in success, pᵢ(n) is increased and all other pⱼ(n) (j≠i) are decreased. Similarly if action αᵢ produces a penalty response, pᵢ(n) is decreased and all other pⱼ(n) modified to preserve the probability measure. A LRI scheme ignores penalty responses from the environment 52, while LRεP only involves small changes in pⱼ(n) compared with changes based on success. Important convergence results have long been proved for these algorithms, and hardware synthesis of the learning algorithms has also been well studied (see, for example, K. S. Narendra and M. A. L. Thathachar, “Learning automata—an introduction”, Prentice Hall, Englewood Cliffs, N.J., 1989, and P. Mars and W. J. Poppelbaum, “Stochastic and Deterministic Averaging Processors”, Peter Peregrinus, 1981).

To apply the learning automaton 50 as an adaptive modulation controller, its output is regarded as the set of switching thresholds 44A. That is, the switching thresholds 44A are partitioned into a number of combinations, the number of which being equal to the number of automaton output actions. Each action is mapped uniquely into a threshold combination. The environment 52 represents the operating environment of the OFDM system 10. The task of the automaton 50, which forms a part of the adaptive scheme block 44 in FIG. 5, is to choose an action that gives the best performance function by interacting with the environment 52. Initially all actions of the automaton 50 are selected with the same probability, and at any iteration or trial only one action is chosen. The environment 52 acts as a “referee” and gives feedback to the automaton 50 via the chosen performance function. Based on the feedback only, the automaton 50 uses a comparison scheme and learning algorithm (see, for example, I. J. Shapiro and K. S. Narendra, “Use of Stochastic Automata for Parameter Self-optimization with Multimodal Performance Criteria”, IEEE Trans. on Systems, Man and Cybernetics, Vol. 5, No. 4, 1969, pp. 352-360, hereafter referred to as Shapiro et al.) to update an internal probability vector that governs the choice of action, or switching thresholds 44A, at the next iteration. In accordance with this embodiment of the invention the environment 52 and stochastic learning automaton 50 in FIG. 6 correspond to the OFDM system 10 and adaptive scheme block 44, respectively, in FIG. 5.

Details of the learning process and steps are now described in further detail for a first embodiment of this invention. Subsequently a description will be provided of an enhancement to this first embodiment, considered herein to be a second embodiment of the invention, where the convergence time of the adaptive scheme block 44, and automaton 50, is increased.

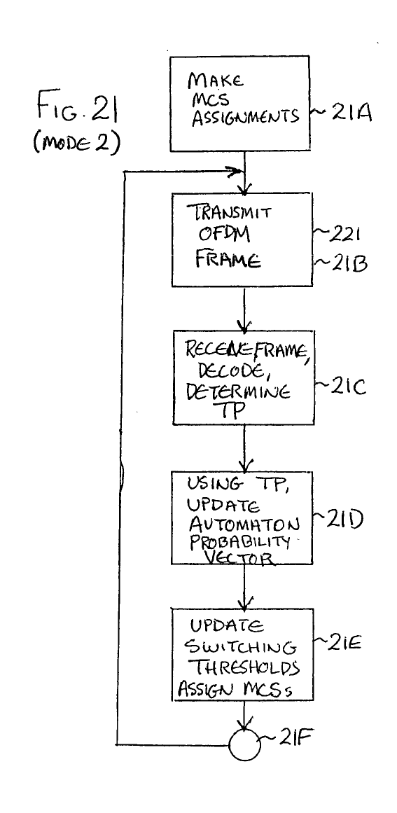

First, the system is initialized with the following steps that are common for mode 1 and 2 operation. Reference is also made to the logic flow diagram of FIG. 19.

Step 19A. The switching thresholds 44A are partitioned into a pre-defined set of combinations. Ideally the combinations should cover the entire operating SNR region with a fine quantization so that the set includes the unknown optimal (or very close to optimal) threshold values. However, this could result in a large number of combinations that would present a difficult control problem. Generally speaking, the greater is the number of threshold combinations, the higher is the resolution, but also the longer the convergence time and the larger the computational load. The enhancement in resolution may or may not justify the increased efforts, and in practice a compromise is made depending on the operating scenario. To demonstrate the present invention it is adequate to choose a small number of threshold combinations, for example two to eight, that cover a reasonable SNR range. Initial threshold values may be obtained from the target BER approach, or by other suitable means, and can then be intuitively adjusted to create a set of MCS switching threshold combinations.

Step 19B. The automaton 50 internal probability vector of the adaptive scheme block 44 is initialized so that the probability of choosing the actions are the same. This insures that all the threshold combinations have an equal chance of being selected initially. The method then maps each action to a unique switching threshold combination. The mapping remains the same for the entire learning process.

Step 19C. Based on the automaton 50 internal probability vector, an action is selected at random. This gives the initial threshold values, which are input to the OFDM system 10.

For mode 1 operation, and referring to the logic flow diagram of FIG. 20, the following steps are performed.

Step 20A. Based on the chosen threshold values, the OFDM system 10 determines what MCS to use in each of the sub-carriers. The MCS assignment determines how many packets an OFDM symbol can carry (or no packets may be assigned at all if the sub-channel conditions are very poor). The sub-carriers are then loaded up with the packets (preferably an integer number of packets).

Step 20B. An OFDM symbol is transmitted by the transmitter 12A.

Step 20C. Since the packets are wholly contained within an OFDM symbol, once the OFDM symbol arrives at the receiver 12B all of the packets may be decoded. The performance evaluation block 42 of FIG. 5 performs a CRC or some other type of error check to determine whether there are any errors in the received packets, and evaluates the PER and throughput resultant from the earlier choice of action (threshold combination).

The throughput is defined as TP=(1-PER)*PPS, where PPS=packets-per-symbol (resultant number ofpackets transmitted per OFDM symbol). The throughput information is sent to the adaptive scheme block 44 as the performance function.

Step 20D. The learning automaton 50 within the adaptive scheme block 44, based on the throughput information received, updates the internal probability vector using a comparison scheme that incorporates, as an example, the conventional LRI or LRP algorithm (see again, for example, Shapiro et al.) If the chosen action has resulted in good performance its selection probability is increased, and vice versa.

Step 20E. An action is chosen at random using the updated automaton probability vector. The updated thresholds 44A are sent to the OFDM system 10. At the next OFDM symbol, appropriate MCSs are assigned to the sub-carriers according to the updated thresholds and an integer number of new packets are loaded.

Step 20F. Control of the process then transfers back to Step 20B to transmit the next OFDM symbol, and the method continues as discussed above.

For mode 2 operation, and referring to the logic flow diagram of FIG. 21, the following steps are performed.

Step 21A. Based on the chosen threshold values, the OFDM system 10 determines what MCSs to use in each of the sub-carriers. Each sub-carrier is loaded with a symbol from its own assigned packet (or no packets may be assigned at all if the sub-channel conditions are very poor). Once a MCS is imposed on a sub-carrier this also determines how long (i.e. how many OFDM symbols) is required to transmit a packet in that sub-carrier, as the MCS is not altered within a packet.

Step 21B. A frame of OFDM symbols is sent by the transmitter 12A.

Step 21C. Since the frame length is dictated by the lowest MCS order available, and is fixed, those sub-carriers with a higher order MCS will carry more than one packet in a frame of OFDM symbols. When an entire frame of packets is received, the performance evaluation block 42 performs a CRC or other type of error check to determine whether any of the received packets are in error, and evaluates the PER and throughput resultant from the earlier choice of action (threshold combination). The throughput (TP) may be defined as TP=(1-PER)*PPF where PPF=packets-per-frame, or TP=(1-PER)*PPS, where PPS=packets-per-symbol. (As the number of OFDM symbols in a frame is fixed, these two definitions are identical within a scaling factor.) The throughput information is sent to the adaptive scheme block 44 as the performance function.

Step 21D. The learning automaton 50 within the adaptive scheme block 44, based on the throughput information received, updates the internal probability vector using the comparison scheme incorporating, for example, the conventional LRI or LRP algorithm (see again, for example, Shapiro et al.) If the selected action yielded good performance its selection probability is increased, and vice versa.

Step 21E. An action is chosen at random using the updated automaton probability vector and the updated thresholds 44A are sent to the OFDM system 10. At the first OFDM symbol of the next frame, appropriate MCSs are assigned to the sub-carriers and data symbols, and the new frame of packets loaded.

Step 21F. Control of the process then transfers back to Step 21B to transmit the next OFDM symbol, and the method continues as discussed above.

As described above, the adaptive scheme block 44 operates differently in mode 1 and 2 because of the different ways the packets are loaded onto the sub-carriers. In mode 1, the adaptive scheme block 44 is invoked once every OFDM symbol, thus the transmission of an OFDM symbol represents a trial of the learning process. In mode 2, the adaptive scheme block 44 is activated once every OFDM frame, thus the transmission of a frame of OFDM symbols is regarded as a trial. Interleaving is also applied differently, i.e., for mode 1 it is performed across all the packets in a single OFDM symbol, while for mode 2 it is performed within a packet only (note that interleaving may not be necessary if the fade rate is slow). In successive trials of both modes, the probabilities of selecting the undesirable actions (that result in a low throughput) gradually decrease, while that of picking the best action (that results in the best throughput) progressively increases to unity.

In the process described thus far the desired goal is to solely maximize the throughput, and no rate-matching is considered. Also, the power of the sub-carriers is not adapted. However, in other embodiments of this invention either one or both of rate-matching and sub-carrier power control may also be implemented.

For mode 1, the adaptive scheme block 44 attempts to place as many packets in an OFDM symbol as possible, while maintaining a low PER so that the overall throughput is maximized. For mode 2, the number of packets carried in a frame of OFDM symbols are dependent on the sub-channel conditions, and the adaptive scheme block 44 attempts to allocate suitable MCSs to the sub-carriers so that the resultant overall average throughput is maximized. In both modes those “bad” sub-carriers that have a high chance of packet failure are preferably disabled (not used) in order to reduce the average PER.

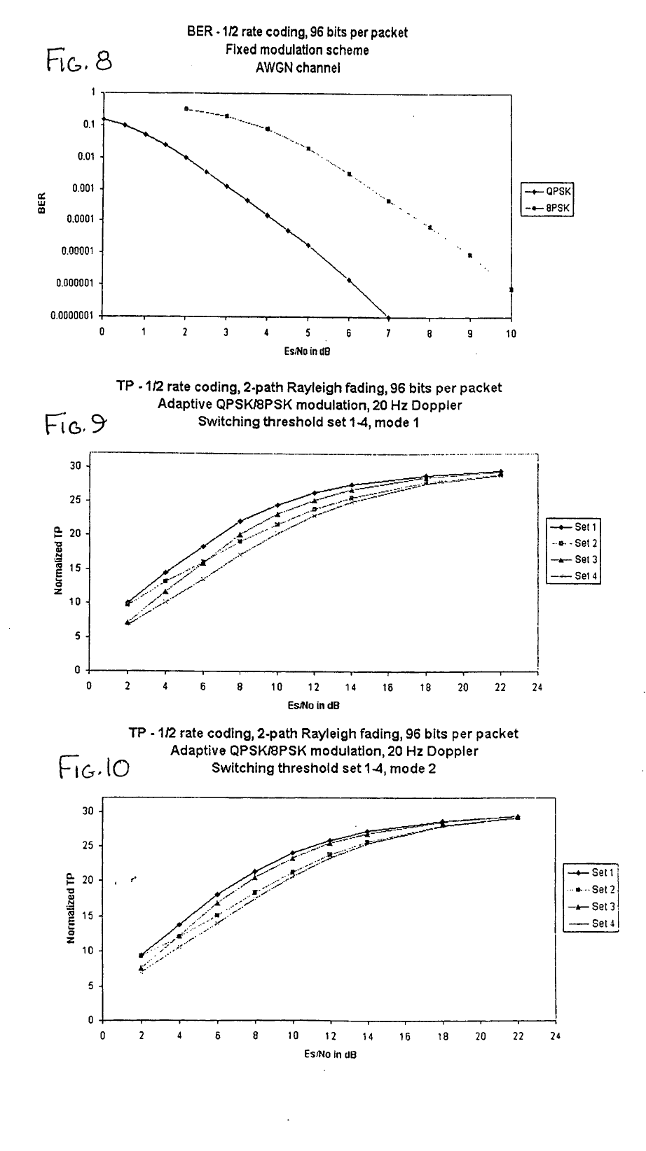

Simulations were performed to demonstrate the effectiveness of the methods discussed above. FIG. 7 shows a block diagram of the simulation system 60, that included a random data source 62, a convolutional encoder and interleaver 64, an adaptive OFDM modulator 66, a two path Rayleigh fading channel model 68, a coherent OFDM demodulator 70, a de-interleaver and soft Viterbi decoder 72, and packet data checker and data output module 74 and, in accordance with this invention, an adaptive OFDM modulation controller 76 receiving inputs from the channel model 68 and from the data output module 74. In the simulation system 60 there are implemented a total of 2048 sub-carriers within an OFDM symbol giving 2048 time samples, to which 202 cyclic prefix samples are added. A time-domain OFDM symbol thus contains a total of 2250 data samples. The sampling frequency was chosen to be 100 MHz, a sub-carrier has a 48.828 KHz bandwidth, and an OFDM symbol occupies 22.5 microseconds. The channel coder 64 is a ° f½ rate convolution encoder based on the IEEE 802.11a standard (IEEE 802.11a standard, “Part 11: Wireless LAN MAC and PHY specifications: High Speed Physical Layer in the 5 GHz Band”, September 1999). Two modulation schemes are made available, QPSK and 8PSK, with coherent demodulation. A packet of data contains 96 data bits (including CRC) and 6 flush bits, thus a packet of encoded symbols consists of 204 real symbols or 102 complex symbols. For operation in mode 1 a packet thus requires 102 sub-carriers, if QPSK is used, and 68 sub-carriers if 8PSK is used instead. An OFDM symbol of 2048 sub-carriers therefore accommodates a maximum of 20 packets, if QPSK is used, or 30 packets if 8PSK is used, or a mixture of them (leaving 8 sub-carriers unused). For the mode 2 configuration an encoded packet has a duration of 102 OFDM symbols, if QPSK is used, or 68 symbols if 8PSK is employed instead. Thus a frame consists of 102 OFDM symbols, during which one packet is transmitted by a QPSK sub-carrier, and 1.5 packets are conveyed by an 8PSK sub-carrier. In order to assess the performance of the adaptive modulation scheme, and the effects of altering the switching thresholds, a normalized throughput (TP) defined as (1-PER)*PPS was employed, where PPS is the number of packets transmitted per OFDM symbol. For fixed QPSK and 8PSK modulation (and with no sub-carriers being disabled), PPS is constant at 20 and 30, respectively. For adaptive modulation PPS can have any value between zero (no transmission) to 30 (8PSK used in all of the sub-carriers). To insure a consistent definition of PPS in mode 1 and 2, only 2040 sub-carriers out of the 2048 available were used.

It should be appreciated that the foregoing construction and operation of the simulation system 60, type of channel coding, numbers of sub-channels, modulation formats and types of modulation formats, numbers of bits and symbols and so forth are provided simply as an example, and are not to be construed in a limiting sense upon the practice of this invention.

In general, for an adaptive modulation system with K MCSs, there are K thresholds to be compared. In the present example, with two modulation schemes (QPSK and 8PSK) there are two thresholds (L1 and L2) to be compared. The first threshold L1 determines when to switch from a no transmission mode to QPSK (when the sub-channel is bad), and the second threshold L2 determines when to switch from QPSK to 8PSK (when the sub-channel is sufficiently good to warrant switching up to the next higher order modulation format). Any sub-channels with an instantaneous SNRN below L1 are disabled and not used for transmission, while any sub-channel having a SNRₙ between L1 and L2 is transmitted using QPSK, and any sub-channel having a SNRₙ above L2 is transmitted using 8PSK.

To facilitate the simulations the following assumptions are made. A first assumption is that perfect channel knowledge is available so that the channel frequency function is always accurately known. In reality, the channel may be estimated via pilot tones or symbols. Channel prediction or tracking techniques may then be used to obtain the channel values between the pilots if necessary. A second assumption is that the modulation scheme selection in the transmitter 12A is reliably passed on to the receiver 12B. In practice this may imply that an additional signaling channel is available between the transmitter 12A and receiver 12B, or that some type of blind detection technique be used at the receiver 12B. A third assumption is that throughput information evaluated at the receiver 12B is available to the transmitter 12A so that the adaptive scheme block 44 can be updated. Alternatively, packet error information may be sent to the transmitter 12A and the throughput calculated there, or the adaptive scheme block 44 may be implemented at the receiver 12B and the determined switching threshold values 44A sent to the transmitter 12A. Again, this may imply the presence of a signaling channel to carry such information from the receiver 12B to the transmitter 12A.

The simulation system 60 was first run with fixed modulations under AWGN, and the resultant BER graph is shown in FIG. 8. Both mode 1 and mode 2 sub-carrier loading gives the same BER results under AWGN, as the noise affects all sub-carriers in the OFDM symbol uniformly. Following the target BER approach, with a 1% BER, L1 may be read from the graph as about 2 dB and L2 as about 5.5 dB. Using these values as a guide, four different sets of threshold combinations are selected to demonstrate the effect of the switching thresholds 44A on performance, as well as to produce a set of reference results. The values chosen are shown in the following Table 1.

TABLE 1

| Threshold combinations | L1 in dB | L2 in dB |
|---|---|---|
| Set 1 | −2 | 6 |
| Set 2 | −2 | 10 |
| Set 3 | 2 | 6 |
| Set 4 | 2 | 10 |

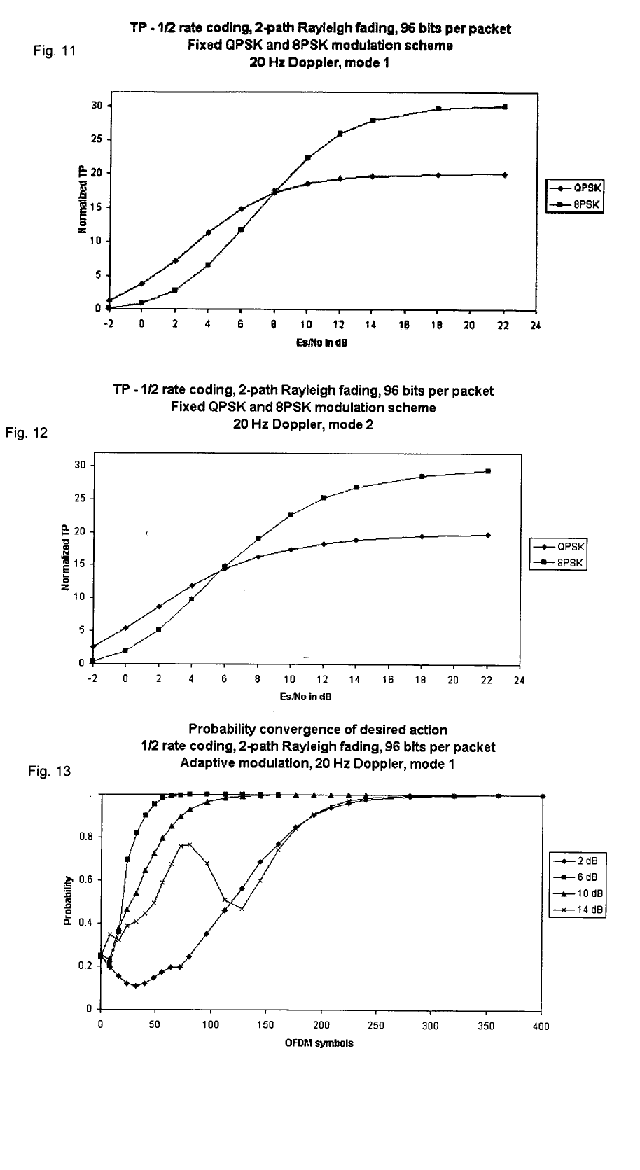

For each set of threshold combinations, the simulation system 60 was operated with a Doppler frequency of 20 Hz, with the packets loaded with the mode 1 and mode 2 configurations. A graph of the resultant TP for mode 1 is depicted in FIG. 9. There it can be seen that the switching threshold values affect the throughput significantly, and that it can vary by as much as 49% at low SNR. The results for the mode 2 configuration are shown in FIG. 10. The corresponding TP graphs for the fixed modulation schemes under the same fading channel conditions are depicted in FIGS. 11 and 12 for modes 1 and 2, respectively. Comparing the results it is clear that the adaptive modulation technique of this invention provides improved performance in either mode of operation, approaching that of 8PSK at high SNRs and improving that of QPSK at low SNRs. The disabling of poor sub-carriers is seen to be beneficial in both adaptive modulation modes. It is also observed that for some values of the switching thresholds 44A the adaptive modulation technique could perform worse than for fixed modulations, further emphasizing the importance of properly adjusting the switching thresholds 44A.

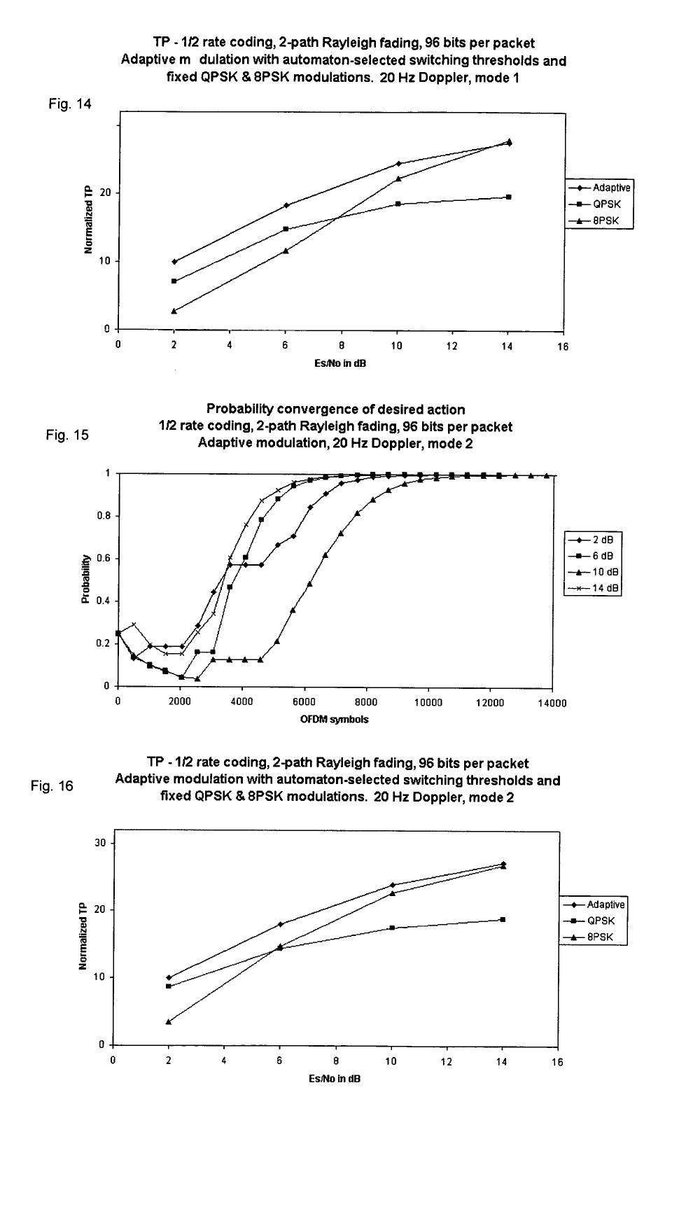

Next, the learning automaton-based adaptive scheme block 44, with a four-action LRI learning algorithm, was applied to select the switching thresholds 44A. Each action of the automaton 50 is mapped uniquely into a candidate threshold set (the same set as used in the reference results). Simulations were performed under the same channel conditions for both the mode 1 and mode 2 configurations. In this particular test scenario the best threshold combination that produces the highest throughput was found to be set 1 across all of the SNRs for both modes (FIGS. 9 and 10). However, for high SNRs, the TP produced by set 1 and set 3 are very close, especially for mode 2, where the loss is merely 1.67% for a SNR of 12 dB and 0.24% for 22 dB (if set 3 is chosen instead of set 1). This is as expected as the two sets of thresholds only differ in L1, which has little or no effect at high SNRs, hence at high SNRs either set may be regarded to produce the best throughput. In all the simulations it was found that the automaton 50 converged to the correct action that produces the best throughput. The probabilities were updated on a symbol-by-symbol basis for mode 1, or on a frame-by-frame (102 OFDM symbols) basis for mode 2, starting from a probability of 0.25 for each action, based entirely on the measured performance criterion. The fading channel model and noise level were found to have no direct effect on the learning process. Only the chosen performance criterion, the averaged TP, determined how the probabilities were altered. After a certain number of trials, the probability for selecting the “good” action gradually increased to 1.0, while that for the “bad” actions decreased to 0.0. FIG. 13 depicts the convergence characteristics for picking the “good” actions for a SNR of 2, 6, 10 and 14 dB for mode 1. The resultant TP graph is shown in FIG. 14, and it is found to be consistent with the reference results. Also shown in FIG. 14 are the TP of fixed QPSK and 8PSK modulations (copied from FIG. 11), and it can clearly be seen that the adaptive modulation, with automaton-selected switching thresholds 44A, outperforms the fixed modulation schemes with up to 4 dB improvement. The corresponding graphs for mode 2 are shown in FIGS. 15 and 16. Again, the superiority of the adaptive modulation with the automaton-selected switching thresholds 44A can be readily seen.

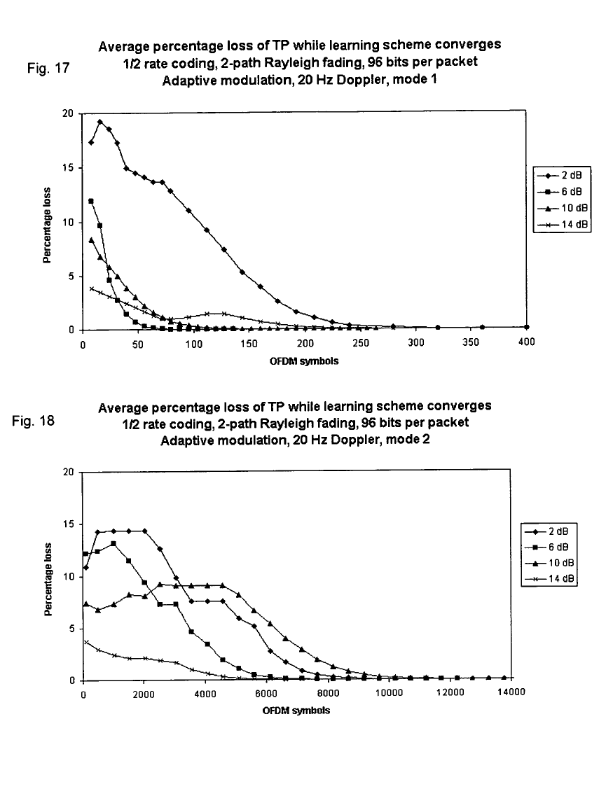

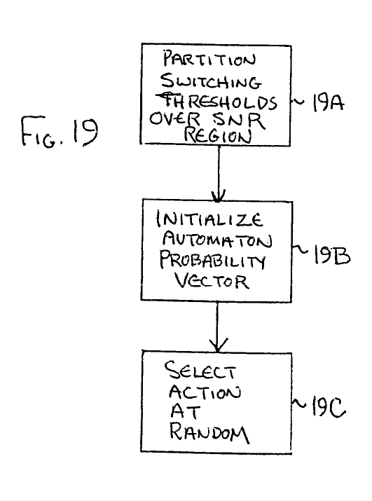

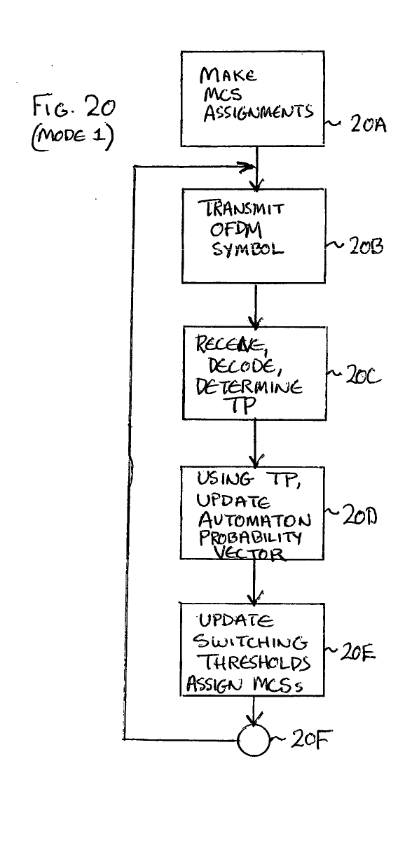

One way of assessing the performance of the adaptive scheme block 44 is to calculate the average percentage loss in TP, defined here as the percentage loss in TP resulting from choosing an action other than the best action while the learning scheme converges. Such graphs are shown in FIGS. 17 and 18 for mode 1 and mode 2, respectively. It is seen that the loss drops to less than 5% after about 150 symbols in mode 1, and 6000 symbols in mode 2.

Comparing the two modes, it is found that the learning scheme takes significantly longer in mode 2 (more OFDM symbols) to converge. This is as to be expected, as a single trial in mode 2 comprises a frame of OFDM symbols, and the automaton 50 is only updated once every 102 OFDM symbols. In contrast, the transmission of a single OFDM symbol constitutes a trial in mode 1, and the automaton is updated once every OFDM symbol. The more frequent updates in mode 1 thus result in a faster convergence of the automaton 50. Although mode 1 may apparently be superior in terms of convergence time, its overall general performance may or may not be superior to that of mode 2 depending on the operating environment. The important point to observe is that the adaptive learning approach implemented by the automaton 50 operates well in both modes of sub-carrier packet loading, and is able to select the correct values for the MCS switching thresholds 44A.

The present case serves as a simple example to illustrate the concept of using the learning automaton 50 in a self-learning scheme for adapting the switching thresholds 44A in the OFDM system 10. It is also possible to increase the number of thresholds to be controlled, or to enhance their partition fineness (increasing the number of partitions). All that is needed is to increase the number of automaton actions, with each action mapping into a specific threshold set.

In summary, the foregoing discussion has described a system and method to adjust the switching thresholds 44A in the adaptive OFDM modem. Unlike the prior art based on either the heuristic or analytical approaches, the present invention provides an alternative solution that has a great potential, especially in practical situations where the heuristic methods offer limited performance and the analytical solutions are difficult or virtually impossible to deploy. The generic and on-line nature of the learning automaton 50 renders the presently preferred performance-goal orientated approach applicable to a wide variety of different OFDM system configurations and operating conditions.

In the foregoing description of the on-line, closed-loop adaptive learning scheme block 44 it was shown that the switching thresholds 44A are dynamically adjusted to improve the throughput. The adaptive learning scheme block 44 is performance-goal orientated, is generic and independent of modulation and coding schemes, and functions to maximize a specific performance function (e.g., the throughput) given a set of switching thresholds 44A. During the adaptation process the performance function is regularly assessed, or probed, and fed to the adaptive scheme block 44 to update the learning automaton 50. This constitutes a trial of the learning process. In the disclosed embodiments the transmission of an OFDM symbol (or a frame of OFDM symbols) is considered as a trial, and hence the automaton 50 is updated only once per OFDM symbol (or per frame), resulting in a relatively slow convergence.

Further in accordance with an enhanced adaptive learning embodiment of this invention, a trial procedure is provided in which the automaton 50 is updated once every packet in order to improve the convergence speed. In order to perform such an update the performance function is assessed after the transmission of every packet. The resultant enhanced adaptive learning scheme block 44 exhibits a substantially reduced convergence time that improves the average throughput during the convergence period, as well as the tracking performance as the channel varies.

Discussing this second embodiment now in greater detail, instead of performing only one trial per OFDM symbol (mode 1) or OFDM frame (mode 2), in this embodiment a trial is carried out on every packet transmitted. Since there are multiple packets per OFDM symbol (or frame), this results in multiple updates of the automaton 50 per OFDM symbol (or frame). The convergence speed can thus be significantly improved. In order to carry out a trial on a packet-by-packet basis the desired performance function, i.e. throughput, is evaluated by the receiver 12B every time a packet is received. To accommodate the increased variance of the measured quantity, this embodiment of the invention also employs active SNR regions in mode 2 operation for the classification of the sub-carriers, since in the mode 2 all of the sub-carriers may not be affected by the changes to the switching thresholds 44A.

Specific details of the learning process and steps are now described. First, the system 10 is initialized with a procedure that is common for either mode 1 or 2 operation. The initialization procedure may be identical to the procedure described above for the first adaptive learning embodiment, and shown in the logic flow diagram of FIG. 19.

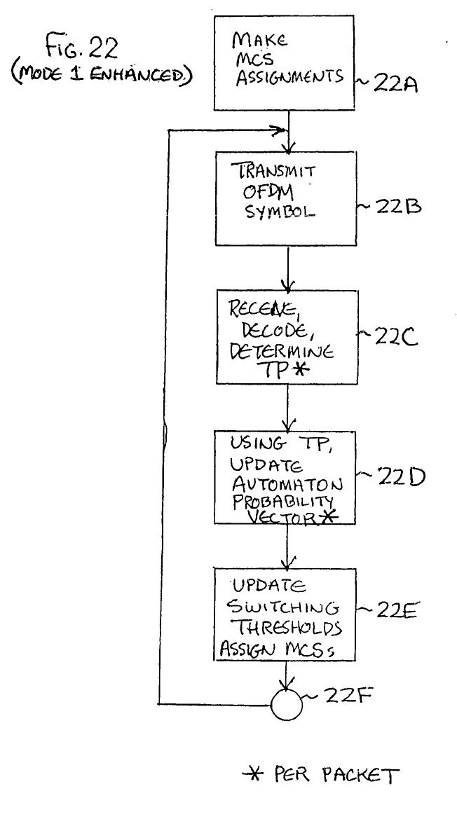

After the initialization procedure is carried out, and for mode 1 operation, the following steps are performed. Reference can also be made to the logic flow diagram of FIG. 22.

Step 22A. Based on the chosen threshold values, the OFDM system 10 determines what MCS to use in each of the sub-carriers. The MCS assignment determines how many packets an OFDM symbol can carry (or no packets may be assigned at all if the sub-channel conditions are very poor). The sub-carriers are then loaded up with the packets (preferably an integer number of packets).

Step 22B. An OFDM symbol is transmitted.

Step 22C. Since the packets are wholly contained within an OFDM symbol, once the OFDM symbol arrives at the receiver 12B all of the packets may be decoded. The performance evaluation block 42 performs an error check (e.g., a CRC check) to determine whether any of the received packets contain an error. The average PER and TP resultant from the action chosen are evaluated for each packet, with TP=(1-PER)*PPS, where PPS=packets-per-symbol (resultant number of packets transmitted per OFDM symbol).

The average TPs, evaluated for each packet, are input to the adaptive scheme block 44 as a set of performance functions.

Step 22D. The learning automaton 50 that contains the adaptive scheme block 44, based on the throughput information received, updates the internal probability vector using a comparison scheme incorporating, in the preferred embodiment, one of the LRI or LRP algorithms (see, again, K. S. Narendra and M. A. L. Thathachar, “Learning automata—an introduction”, Prentice Hall, Englewood Cliffs, N.J., 1989, and I. J. Shapiro and K. S. Narendra, “Use of Stochastic Automata for Parameter Self-optimization with Multimodal Performance Criteria”, IEEE Trans. on Systems, Man and Cybernetics, Vol. 5, No. 4, 1969, pp. 352-360). If the chosen action yielded a good performance its selection probability is increased, and vice versa. As this update procedure is performed for each packet received, if there are n packets received in an OFDM symbol, the automaton will be updated n times.

Step 22E. An action is chosen at random using the updated automaton 50 probability vector, and the updated switching thresholds 44A are sent to the OFDM system 10. At the next OFDM symbol, an appropriate MCS or MCSs are assigned to the sub-carriers according to the updated thresholds 44A, and an integer number of new packets are loaded to the sub-carriers.

Step 22F. Control of the process then transfers back to Step 22B to transmit the next OFDM symbol, and the method continues as discussed above.

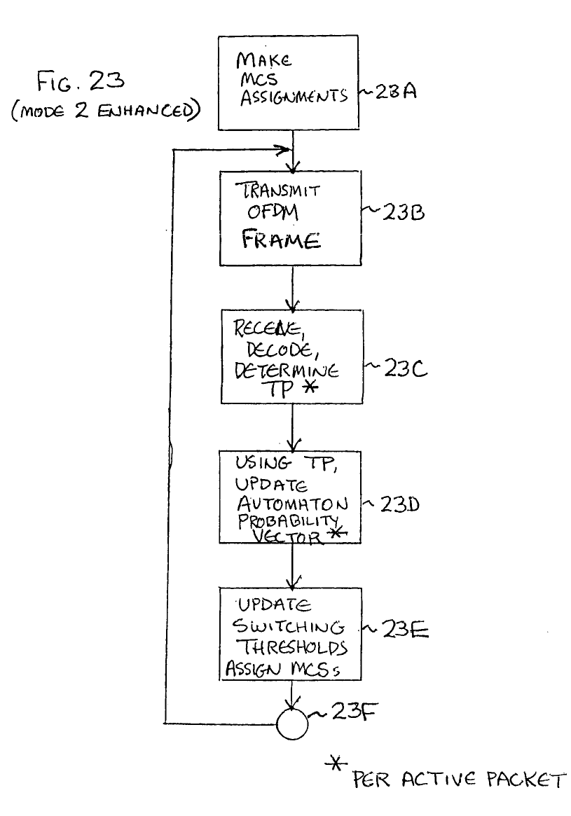

For mode 2 operation the following steps are performed, as shown in FIG. 23.

Step 23A. Based on the chosen threshold values, the OFDM system 10 determines what MCSs to use in each of the sub-carriers. Each sub-carrier is loaded with a symbol from its own assigned packet (or no packets may be assigned at all if the sub-channel conditions are very poor). Once a MCS is imposed on a sub-carrier this also determines how long (i.e. how many OFDM symbols) is required to transmit a packet in that sub-carrier, as the MCS is not altered within a packet.

Step 23B. A frame of OFDM symbols is sent by the transmitter 12A.

Step 23C. Since the frame length is dictated by the lowest MCS order available, and is fixed, those sub-carriers with a higher order MCS will carry more than one packet in a frame of OFDM symbols. When an entire frame of packets is received by the receiver 12B, the performance evaluation block 42 performs an error check (such as a CRC check) to determine whether the received packets are in error, and evaluates the PER and TP resultant from the earlier choice of action (threshold combination) for those packets in the active SNR region only. The active region is defined as the SNR range covered by the available combinations of switching thresholds 44A, as discussed in further detail below. For each of the active packets, the resultant average TP from the action chosen may be evaluated either by TP=(1-PER)*PPF, where PPF=packets-per-frame, or TP=(1-PER)*PPS, where PPS=packets-per-symbol.

The average TPs, evaluated for each active packet, are sent to the adaptive scheme block 44 as the set of performance functions.

Step 23D. The learning automaton 50 that contains the adaptive scheme block 44, based on the throughput information received, updates the internal probability vector using a comparison scheme incorporating, in the preferred embodiment, one of the LRI or LRP algorithms (see, again, K. S. Narendra et al. and I. J. Shapiro et al.). If the chosen action yielded a good performance its selection probability is increased, and vice versa. This update procedure is performed for each active packet received. Thus, if there are n active packets received in an OFDM frame, the automaton 50 will be updated n times.

Step 23E. An action is chosen at random using the updated automaton 50 probability vector. The updated thresholds 44A are sent to the OFDM system 10, and at the first OFDM symbol of the next frame, appropriate MCSs are assigned to the sub-carriers and data symbols from the new frame of packets are loaded onto the sub-carriers.

Step 23F. Control of the process then transfers back to Step 23B to transmit the next OFDM symbol, and the method continues as described.

As was discussed above, the adaptive scheme block 44 operates differently in mode 1 and mode 2 because of the different ways the packets are loaded onto the sub-carriers. In mode 1, the switching thresholds 44A are selected by the automaton 50 once per OFDM symbol, but the automaton is updated once per received packet. Since there are multiple packets per OFDM symbol the update occurs multiple times per OFDM symbol. In mode 2, however, the switching thresholds 44A are selected by the automaton 50 once per OFDM frame (which contains tens or hundreds of OFDM symbols), but the automaton 50 is updated once per received packet. Since there are multiple packets per OFDM frame the update occurs multiple times per OFDM frame. Because the automaton 50 is updated on a packet-by-packet basis for both modes of operation, the transmission of a packet constitutes a trial of the learning process.

The concept of the active SNR region is employed in this embodiment of the invention for use in mode 2 only. For mode 1 any changes in the values of the switching threshold 44A will affect all of the packets carried by the OFDM symbol, as the data symbols from all the packets are interleaved across the sub-carriers. However, in mode 2 the situation is different, i.e., each sub-carrier is loaded with its own packet that is spread in time across a number of OFDM symbols. Interleaving, if desired, is performed within a packet only. Hence a change in the values of the switching threshold 44A only affects the MCS allocation of a limited number, and not all, of the sub-carriers. This is illustrated in FIG. 24, where an example of the sub-carrier SNR is plotted. Two threshold levels are shown, where threshold L1 determines the SNR level to switch from no transmission to MCS1 (e.g., to QPSK), and threshold L2 determines when to switch from MCS1 to MCS2 (e.g., from QPSK to 8PSK). Each of the thresholds L1 and L2 is defined by two values: t11 and t12, and t21 and t22, respectively. It can be seen that altering L1 from t11 to t12 only affects the sub-carriers with SNRs between t11 and t12. That is, by changing the value of L1 from t11 to t12, only the sub-carriers having a SNR in the region between t11 to t12 transit from MCS1 to no transmission. All other sub-carriers' MCS allocations are unaffected by this change. A similar situation applies to L2. The regions between the lower and upper threshold bounds (e.g., between t11 and t12) are referred to herein as the active regions, and only those sub-carriers in these regions affect the TP performance when the switching thresholds 44A are adjusted. Therefore, only the packets carried by the sub-carriers in these regions, referred to herein as the active packets, are employed in the automaton 50 update process in mode 2.

The enhanced operation of the adaptive scheme block 44, in accordance with the second embodiment of this invention, thus differs in several respects from the operation of the adaptive scheme block 44 in accordance with the first embodiment of this invention. For example, the trial process involves the transmission of a packet, and the resultant packet-based TP is used to update the internal probability vector of the automaton 50. Since there are multiple packets in an OFDM symbol (mode 1) or OFDM frame (mode 2), the automaton 50 is updated multiple times per OFDM symbol (mode 1) or OFDM frame (mode 2). This improves the convergence speed in both modes. Furthermore, the second embodiment employs the concept of the active regions and active packets in mode 2, as discussed above and shown in FIG. 24. In this embodiment only packets from the active regions are used to evaluate the performance function TP. In addition, and due to the modified trial process, the average PER and TP are evaluated and updated on a per packet basis in both mode 1 and 2.

These enhancements improve the convergence speed by virtue of the multiple updates per OFDM symbol (or frame) so that in successive transmissions of OFDM symbols (or frames), the probabilities of selecting the undesirable actions (that result in a low throughput) decrease more rapidly, while the probability of selecting the best action (that results in high throughput) increases faster towards unity.

As in the first embodiment, the desired target or goal is to maximize the throughput, and no rate-matching is considered, nor is the power of the sub-carriers adapted. However, in other embodiments of this invention one or both of these actions could also be used as a target to be optimized through the learning process conducted by the automaton 50.

The operation of the second embodiment of this invention was simulated using the same simulation system 60 (FIG. 7), and with the same conditions, as the first embodiment as discussed above.

As in the simulation discussion of the first embodiment, and in general, for an adaptive modulation system with K MCSs, there are K thresholds to be compared. In this example, with two modulation schemes (QPSK and 8PSK) there are two thresholds (L1 and L2) to be compared. The first threshold L1 determines when to switch from a no transmission mode to QPSK (when the sub-channel is bad), and the second threshold L2 determines when to switch from QPSK to 8PSK (when the sub-channel is sufficiently good to warrant switching up to the next higher order modulation format). Any sub-channels with an instantaneous SNRN below L1 are disabled and not used for transmission, while any sub-channel having a SNRN between L1 and L2 is transmitted using QPSK, and any sub-channel having a SNRN above L2 is transmitted using 8PSK.

Also, the same assumptions are made as were made with regard to the first embodiment. That is, the first assumption is that perfect channel knowledge is available so that the channel frequency function is always accurately known. The second assumption is that the modulation scheme selection in the transmitter 12A is reliably passed on to the receiver 12B. The third assumption is that throughput information evaluated at the receiver 12B is available to the transmitter 12A so that the adaptive scheme block 44 can be updated. As was assumed previously, a suitable signaling mechanism is in place between the transmitter 12A and the receiver 12B.

Also, the threshold partitioning shown in Table 1 above was assumed for the simulation of the second embodiment, and the throughput curves shown in FIGS. 9 and 10 apply as well to this case. Each threshold combination produces a different TP performance. Again, the channel model is a two-path Rayleigh fading with a Doppler frequency of 20 Hz. In this particular test scenario the best threshold combination that produces the highest throughput happens to be set 1 across all the SNRs for both modes.

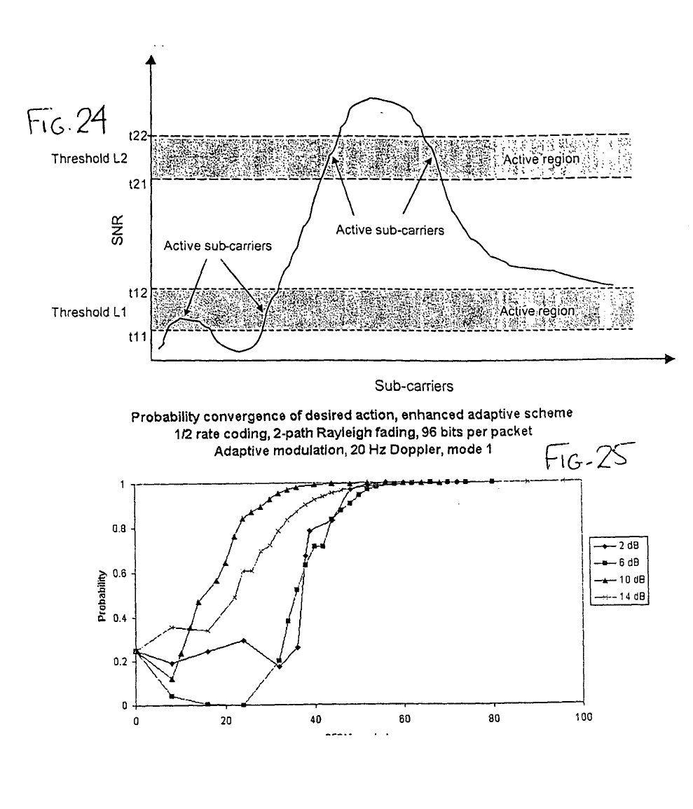

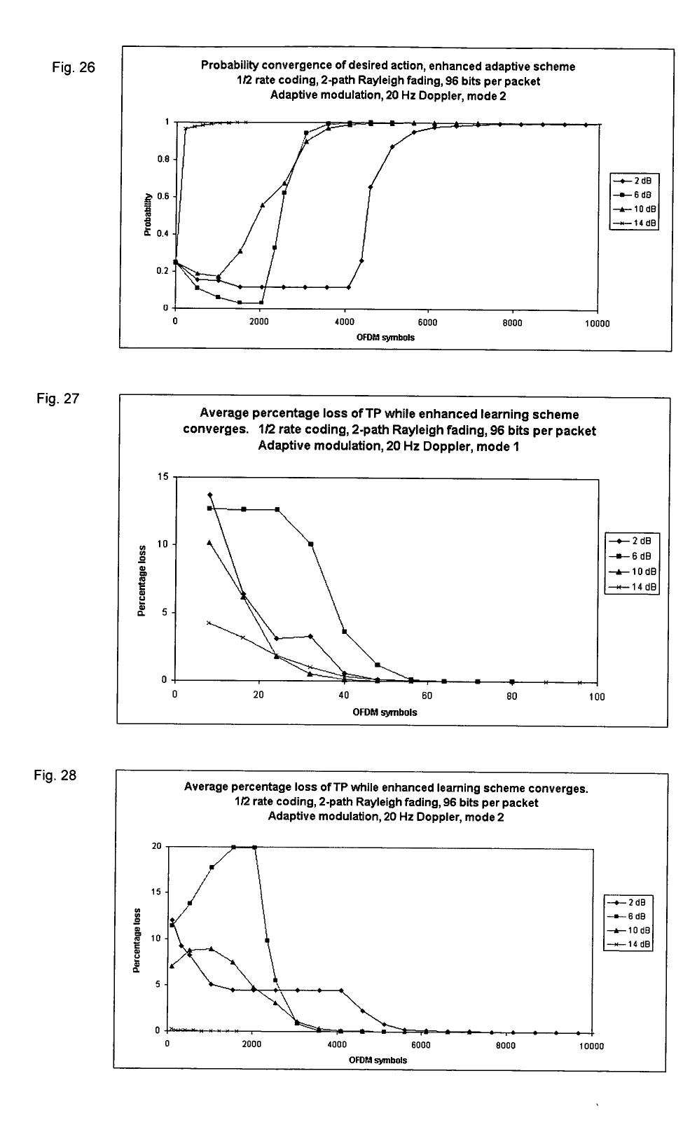

The enhanced adaptive scheme block 44, with a four-action LRI learning algorithm, was applied to select the switching thresholds 44A. Each action of the automaton 50 maps uniquely into a candidate threshold set. Simulations were performed under the same channel conditions for both mode 1 and mode 2 configurations. In all the simulations it was found that the automaton 50 converged to the proper action that produces the highest throughput. The probabilities were updated in a packet-by-packet basis for both mode 1 and 2, starting from a probability of 0.25 for each action, based entirely on the measured performance criterion. The fading channel model and noise level had no direct effect on the learning process. Only the chosen performance criterion, the averaged TP, determined how the probabilities were altered. After a certain number of trials, the probability for selecting the good action gradually increased to 1.0, while that for the bad actions decreased to 0.0. FIG. 25 depicts the convergence characteristics for the good action (that gives the best throughput) for a SNR of 2, 6, 10 and 14 dB for mode 1. The convergence results for mode 2 are shown in FIG. 26 for the same SNRs. Comparing FIGS. 25 and 26 with similar results for the first embodiment, it is clear that the enhanced adaptive learning scheme block 44 offers a significantly faster convergence speed for mode 1, and a noticeably faster convergence speed for mode 2. The reason for the smaller improvement in mode 2 is that only the active packets are used to update the automaton 50, and in addition the updates in mode 2 only occur every frame of OFDM symbols. Hence the convergence time (in terms of number of OFDM symbols) can be expected to be longer than in mode 1.

As was discussed above with regard to the first embodiment, although mode 1 may apparently exhibit a faster convergence time, its overall general performance may or may not be superior to mode 2. The important point to observe is that the operation of the adaptive scheme block 44 under the enhanced learning algorithm improves the convergence speed of both mode 1 and mode 2.

Another way of assessing the performance of the adaptive scheme block 44 is to calculate the average percentage loss in TP, defined here as the percentage loss in TP resulted from choosing an action other than the best one while the learning scheme converges. These graphs are shown in FIGS. 27 and 28 for mode 1 and mode 2, respectively. It is seen that the loss drops to less than 2% after about 50 symbols in mode 1, and after about 4500 symbols in mode 2. Both graphs demonstrate a considerable improvement over the operation of adaptive learning scheme block 44 in the first embodiment (compare FIGS. 17 and 18 to FIGS. 27 and 28, respectively), thus improving the average throughput during the convergence period.

The resultant TP after convergence is the same as reported above for the first embodiment, with the same improvement over fixed QPSK and 8PSK modulation schemes. The enhanced learning scheme block 44 improves on the convergence speed only, without altering the throughput performance or affecting other features and advantages of the adaptive learning scheme block 44 operating in accordance with the first embodiment. The faster convergence speed also facilitates tracking channel variations, and increases the average throughput when the learning scheme block 44 attempts to select the appropriate values for the thresholds 44A in response to a change in channel conditions.

The foregoing description has provided by way of exemplary and non-limiting examples a full and informative description of the best methods and apparatus presently contemplated by the inventors for carrying out the invention. However, various modifications and adaptations may become apparent to those skilled in the relevant arts in view of the foregoing description, when read in conjunction with the accompanying drawings and the appended claims. As but some examples, and as was noted, changes may be made in the numbers of OFDM sub-channels, frequencies, numbers of bits used, types and numbers of modulation schemes, and so forth, by those skilled in the art. However, all such and similar modifications of the teachings of this invention will still fall within the scope of this invention. Further, while the method and apparatus described herein are provided with a certain degree of specificity, the present invention could be implemented with either greater or lesser specificity, depending on the needs of the user. Further, some of the features of the present invention could be used to advantage without the corresponding use of other features. As such, the foregoing description should be considered as merely illustrative of the principles of the present invention, and not in limitation thereof, as this invention is defined by the claims which follow.

1. A method for operating an orthogonal frequency duplex multiplexing (OFDM) communications system, comprising:
when transmitting data over a plurality of OFDM sub-channels from an OFDM transmitter to an OFDM receiver through a channel,
operating an adaptive learning automaton to adjust values of modulation coding scheme (MCS) switching thresholds so as to maximize at least one selected performance criterion;
based on the values of the switching thresholds, selecting a MCS and modulating data with the selected MCS; and
transmitting the modulated data over at least some of the sub-channels.

2. A method as in claim 1, further comprising:
receiving the data at the OFDM receiver; and
demodulating the received data using a demodulator that corresponds to the selected MCS.

3. A method as in claim 2, where the automaton is located at the OFDM transmitter, and where feedback information that is indicative of the at least one selected performance criterion is signaled from the OFDM receiver to the OFDM transmitter, and where information indicative of the selected MCS is signaled from the OFDM transmitter to the OFDM receiver.

4. A method as in claim 2, where the automaton is located at the OFDM receiver, and where information that is indicative of the selected MCS is signaled from the OFDM receiver to the OFDM transmitter.

5. A method as in claim 1, where the selected performance criterion comprises data throughput.

6. A method as in claim 1, where the OFDM communications system operates by loading a plurality of data packets across the plurality of sub-carriers so that the plurality of data packets are loaded into one OFDM symbol.

7. A method as in claim 1, where the OFDM communications system operates by loading each sub-carrier with a data packet so that each data packet is spread across a plurality of OFDM symbols.

8. A method as in claim 1, further comprising a step of initializing the automaton by:
partitioning the switching thresholds into a pre-defined set of combinations to cover all or substantially all of a range of operating signal-to-noise ratios (SNRs);
initializing an internal probability vector of the automaton such that the probabilities of choosing a particular action are the same;
mapping each particular action to a unique switching threshold combination; and
selecting an action at random.

9. A method as in claim 8, where for a mode 1 operation where the OFDM communications system operates by loading a plurality of data packets across the plurality of sub-carriers so that the plurality of data packets are loaded into one OFDM symbol, further comprising:
based on selected switching threshold values, determining what MCS to use in each of the sub-carriers, thereby determining how many data packets an OFDM symbol can carry;
loading the sub-carriers with the data packets;
transmitting the OFDM symbol from the OFDM transmitter;
receiving the OFDM symbol at the OFDM receiver and determining a packet error rate (PER) to determine data throughput (TP), TP=(1-PER)*PPS, where PPS=packets-per-symbol;
based on the data throughput, updating the internal probability vector of the automaton such that only if the selected action has resulted in good throughput performance the selection probability of the selected action is increased, thereby updating the switching threshold values;
selecting another action at random using the updated automaton internal probability vector; and
at the next OFDM symbol, assigning MCSs to the sub-carriers according to the updated switching threshold values, loading new data packets to the sub-carriers accordingly, and transmitting the next OFDM symbol.

10. A method as in claim 8, where for a mode 2 operation where the OFDM communications system operates by loading each sub-carrier with a data packet so that each data packet is spread across a plurality of OFDM symbols, further comprising:
based on selected switching threshold values, determining what MCS to use in each of the sub-carriers, and loading each sub-carrier with a symbol from an assigned data packet;
transmitting a frame of OFDM symbols from the OFDM transmitter;
receiving the frame of OFDM symbols at the OFDM receiver and determining a packet error rate (PER) to determine data throughput (TP), TP=(1-PER)*PPF, where PPF=packets-per-frame, or TP=(1-PER)*PPS, where PPS=packets-per-symbol;
based on the data throughput, updating the internal probability vector of the automaton such that only if the selected action has resulted in good throughput performance the selection probability of the selected action is increased, thereby updating the switching threshold values;
selecting another action at random using the updated automaton internal probability vector; and
at the first OFDM symbol of the next frame, assigning MCSs to the sub-carriers according to the updated switching threshold values, loading a new frame of data packets to the sub-carriers accordingly, and transmitting the next frame of OFDM symbols.

11. A method as in claim 9, where loading the sub-channels further comprises disabling a sub-channel and not loading a data packet if the sub-channel condition is poor.

12. A method as in claim 10, where loading the sub-channels further comprises disabling a sub-channel and not loading a data packet if the sub-channel condition is poor.

13. A method as in claim 9, where one automaton learning trial is performed per OFDM symbol.

14. A method as in claim 10, where one automaton learning trial is performed per OFDM frame.

15. A method as in claim 8, where for a mode 1 operation where the OFDM communications system operates by loading a plurality of data packets across the plurality of sub-carriers so that the plurality of data packets are loaded into one OFDM symbol, further comprising:
based on selected switching threshold values, determining what MCS to use in each of the sub-carriers, thereby determining how many data packets an OFDM symbol can carry;
loading the sub-carriers with the data packets;
receiving the OFDM symbol at the OFDM receiver and determining a packet error rate (PER) to determine data throughput (TP) in accordance with:
TP=(1-PER)*PPS, where PPS=packet-per-symbol;
based on the average TP, updating the internal probability vector of the automaton such that only if the selected action has resulted in good throughput performance the selection probability of the selected action is increased, thereby updating the switching threshold values, where the automaton internal probability vector is updated for each packet received in an OFDM symbol;
selecting another action at random using the updated automaton internal probability vector; and
at the next OFDM symbol, assigning MCSs to the sub-carriers according to the updated switching threshold values, loading new data packets to the sub-carriers accordingly, and transmitting the next OFDM symbol.

16. A method as in claim 8, where for a mode 2 operation where the OFDM communications system operates by loading each sub-carrier with a data packet so that each data packet is spread across a plurality of OFDM symbols, further comprising:
based on selected switching threshold values, determining what MCS to use in each of the sub-carriers, and loading each sub-carrier with a symbol from an assigned data packet;
transmitting a frame of OFDM symbols from the OFDM transmitter;
receiving the frame of OFDM symbols at the OFDM receiver and determining a packet error rate (PER) to determine data throughput (TP), where the PER and TP are determined only for those packets (active packets) in an active SNR region defined as a SNR range covered by the available combinations of switching thresholds, and where PER and TP are determined in accordance with:
TP=(1-PER)*PPF, where PPF=packets-per-frame, or TP=(1-PER)*PPS, where PPS=packets-per-symbol;
based on the averaged data throughput for active packets only, updating the internal probability vector of the automaton such that only if the selected action has resulted in good throughput performance the selection probability of the selected action is increased, thereby updating the switching threshold values, where the automaton internal probability vector is updated for each active packet received in a OFDM frame;
selecting another action at random using the updated automaton internal probability vector; and
at the first OFDM symbol of the next frame, assigning MCSs to the sub-carriers according to the updated switching threshold values, loading a new frame of data packets to the sub-carriers accordingly, and transmitting the next frame of OFDM symbols.

17. An orthogonal frequency duplex multiplexing (OFDM) communications system, comprising:
an OFDM transmitter for transmitting data over a plurality of OFDM sub-channels, said OFDM transmitter comprising a plurality of modulators of different types;
an OFDM receiver for receiving the data from the plurality of OFDM sub-channels, said OFDM receiver comprising a plurality of corresponding demodulators of the different types; and
an adaptive learning automaton for adjusting values of modulation coding scheme (MCS) switching thresholds so as to maximize at least one selected performance criterion, said OFDM transmitter being responsive to the MCS switching thresholds for selecting an appropriate one or ones of said modulators for modulating the data for various ones of the sub-channels.

18. An OFDM communications system as in claim 17, where said OFDM receiver demodulates the received data using one or more demodulators that correspond to the selected modulators.

19. An OFDM communications system as in claim 18, where the automaton is located at the OFDM transmitter, and where feedback information that is indicative of the at least one selected performance criterion is signaled from the OFDM receiver to the OFDM transmitter, and where information indicative of the selected MCS is signaled from the OFDM transmitter to the OFDM receiver.

20. An OFDM communications system as in claim 18, where the automaton is located at the OFDM receiver, and where information that is indicative of the selected MCS is signaled from the OFDM receiver to the OFDM transmitter.

21. An OFDM communications system as in claim 17, where the selected performance criterion comprises data throughput.

22. An OFDM communications system as in claim 17, where the OFDM communications system operates by loading a plurality of data packets across the plurality of sub-carriers so that the plurality of data packets are loaded into one OFDM symbol.

23. An OFDM communications system as in claim 17, where the OFDM communications system operates by loading each sub-carrier with a data packet so that each data packet is spread across a plurality of OFDM symbols.

24. An OFDM communications system as in claim 17, further comprising means for initializing the automaton by partitioning the switching thresholds into a pre-defined set of combinations to cover all or substantially all of a range of operating signal-to-noise ratios (SNRs); initializing an internal probability vector of the automaton such that the probabilities of choosing a particular action are the same; mapping each particular action to a unique switching threshold combination; and selecting an action at random.

25. An OFDM communications system as in claim 24, where for a mode 1 operation the OFDM communications system operates by loading a plurality of data packets across the plurality of sub-carriers so that the plurality of data packets are loaded into one OFDM symbol, and further comprising means, responsive to selected switching threshold values, for determining what MCS to use in each of the sub-carriers, thereby determining how many data packets an OFDM symbol can carry; for loading the sub-carriers with the data packets; for transmitting the OFDM symbol from the OFDM transmitter; for receiving the OFDM symbol at the OFDM receiver and determining a packet error rate (PER) to determine data throughput; and means, responsive to the determined data throughput, for updating the internal probability vector of the automaton such that only if the selected action has resulted in good throughput performance the selection probability of the selected action is increased, thereby updating the switching threshold values, and for selecting another action at random using the updated automaton internal probability vector and, at the next OFDM symbol, assigning MCSs to the sub-carriers according to the updated switching threshold values, loading new data packets to the sub-carriers accordingly, and transmitting the next OFDM symbol.

26. An OFDM communications system as in claim 24, where for a mode 2 operation the OFDM communications system operates by loading each sub-carrier with a data packet so that each data packet is spread across a plurality of OFDM symbols, and further comprising means, responsive to selected switching threshold values, for determining what MCS to use in each of the sub-carriers, and loading each sub-carrier with a symbol from an assigned data packet; for transmitting a frame of OFDM symbols from the OFDM transmitter; for receiving the frame of OFDM symbols at the OFDM receiver and determining a packet error rate (PER) to determine data throughput; and means, responsive to the determined data throughput, for updating the internal probability vector of the automaton such that only if the selected action has resulted in good throughput performance the selection probability of the selected action is increased, thereby updating the switching threshold values; for selecting another action at random using the updated automaton internal probability vector and, at the first OFDM symbol of the next frame, for assigning MCSs to the sub-carriers according to the updated switching threshold values, loading a new frame of data packets to the sub-carriers accordingly, and transmitting the next frame of OFDM symbols.

27. An OFDM communications system as in claim 25, where loading the sub-channels further comprises disabling a sub-channel and not loading a data packet if the sub-channel condition is poor.

28. An OFDM communications system as in claim 26, where loading the sub-channels further comprises disabling a sub-channel and not loading a data packet if the sub-channel condition is poor.

29. An OFDM communications system as in claim 25, where one automaton learning trial is performed per OFDM symbol.

30. An OFDM communications system as in claim 25, where one automaton learning trial is performed per OFDM frame.

31. An OFDM communications system as in claim 24, where for a mode 1 operation the OFDM communications system operates by loading a plurality of data packets across the plurality of sub-carriers so that the plurality of data packets are loaded into one OFDM symbol, and further comprising means, responsive to selected switching threshold values, for determining what MCS to use in each of the sub-carriers, thereby determining how many data packets an OFDM symbol can carry; for loading the sub-carriers with the data packets; for receiving the OFDM symbol at the OFDM receiver and determining a packet error rate (PER) to determine data throughput (TP) in accordance with:
TP=(1-PER)*PPS, where PPS=packets-per-symbol;
further comprising means, responsive to the average TP, for updating the internal probability vector of the automaton such that only if the selected action has resulted in good throughput performance the selection probability of the selected action is increased, thereby updating the switching threshold values, where the automaton internal probability vector is updated for each packet received in an OFDM symbol; for selecting another action at random using the updated automaton internal probability vector and, at the next OFDM symbol, for assigning MCSs to the sub-carriers according to the updated switching threshold values, loading new data packets to the sub-carriers accordingly, and transmitting the next OFDM symbol.

32. An OFDM communications system as in claim 24, where for a mode 2 operation the OFDM communications system operates by loading each sub-carrier with a data packet so that each data packet is spread across a plurality of OFDM symbols, and further comprising means, responsive to selected switching threshold values, for determining what MCS to use in each of the sub-carriers, and loading each sub-carrier with a symbol from an assigned data packet; for transmitting a frame of OFDM symbols from the OFDM transmitter; for receiving the frame of OFDM symbols at the OFDM receiver and determining a packet error rate (PER) to determine data throughput (TP),where the PER and TP are determined only for those packets (active packets) in an active SNR region defined as a SNR range covered by the available combinations of switching thresholds, and where PER and TP are determined in accordance with:
TP=(1-PER)*PPF, where PPF=packets-per-frame, or TP=(1-PER)*PPS, where PPS=packets-per-symbol;
further comprising means, responsive to the averaged data throughput for active packets only, for updating the internal probability vector of the automaton such that only if the selected action has resulted in good throughput performance the selection probability of the selected action is increased, thereby updating the switching threshold values, where the automaton internal probability vector is updated for each active packet received in an OFDM frame; for selecting another action at random using the updated automaton internal probability vector and, at the first OFDM symbol of the next frame, for assigning MCSs to the sub-carriers according to the updated switching threshold values, loading a new frame of data packets to the sub-carriers accordingly, and transmitting the next frame of OFDM symbols.
